(19) United States
(12) Patent Application Publication
(10) Pub. No.: US 2009/0177344 A1
(43) Pub. Date: Jul. 9, 2009

(54) Method for the Onboard Determination of Train Detection, Train Integrity and Positive Train Separation

(75) Inventors: Demetri James, Flushing, NY (US); Warren H. Klinck, JR., Merrick, NY (US)

Correspondence Address: Lockheed Martin c/o;DEMONT & BREYER, LLC, 100 COMMONS WAY, Ste. 250, HOLMDEL, NJ, 07733, US

(73) Assignee: LOCKHEED MARTIN CORPORATION, Bethesda, MD (US)

(21) Appl. No.: 12/351,373

(22) Filed: Jan. 9, 2009

Related U.S. Application Data
(60) Provisional application No. 61/020,015, filed on Jan. 9, 2008.

(51) Int. Cl. G01C 21/00; G05D 1/00

(52) U.S. Cl. 701/19; 701/96; 701/207

(57) ABSTRACT

A system and method for onboard train detection is disclosed. In some embodiments, the train detection function is segregated into a safety-critical head-of-train determination, a safety-critical end-of-train (or length-of-train) determination, and a safety-critical train integrity function. By supplementing the train detection and integrity functions with information on system latencies, guard zones, processing delays and a determination of safe braking distance, the method and system provides safety-critical onboard positive train separation information. This information is transmitted to a control center and used to determine safe separation distance between trains.

### STATEMENT OF RELATED CASES

This case claims priority of U.S. Provisional Patent Application 61/020,015, filed on Jan. 9, 2008 and incorporated by reference herein.

### FIELD OF THE INVENTION

The present invention relates to railway safety in general, and, more particularly, to train detection, train integrity and positive train separation.

### BACKGROUND OF THE INVENTION

Train “detection” is the safety-critical determination of the presence or absence of a train on a defined section (“block”) of a railway network. Once the block occupancy information is obtained, it is used in conjunction with track switch positions, etc., to determine route availability for trains.

The location of a train in a railway network has historically been determined using trackside equipment, such as track circuits and/or axle counters. Track circuits are typically implemented by applying an electrical voltage to the track. The electrical voltage is sensed by trackside equipment only if no train is present. When a train enters the block, the track voltage is shorted and no voltage sensed by the trackside equipment. An absence of voltage indicates the presence of a train. Since blocks are typically several miles long in order to minimize costs, this technique provides a relatively coarse location resolution that is usually updated or supplemented via voice reports by the crew over a radio link.

Axle counters are trackside devices that sense a magnetic flux change caused by the passage of a train's wheels, hence counting the “axles” that pass the counters. While axle counters can have a higher reliability than track circuits, when they fail or have an error condition, severe operational delays may be incurred in the process of re-establishing track occupancy for safe train operation.

Other and more sophisticated trackside arrangements include transponders or beacons that exchange radio frequency signals to a train-mounted receiver that can be used to determine location and block occupancy.

While trackside systems have historically functioned well, they can be expensive to install and maintain. Also, they cannot be used in un-signaled (“dark”) territories, thereby rendering areas of the track system without train detection functionality.

Train “integrity” is the safety-critical determination that the train “consist,” as defined on train initialization, has not been compromised by a train break or separation. Train integrity is performed in signaled territories by detecting a loss of brake-line pressure and via use of track circuits and axle counters. To improve performance on the railway, more signaled territory with smaller blocks is required. This requirement for additional signaling is disadvantageously accompanied by higher installation and operating costs.

In un-signaled (dark) territories, a rudimentary train integrity function could be performed by detecting a loss of brake-line pressure; however, the safety case for this method is limited.

Known onboard train integrity schemes have utilized “end-of-train” systems. These are GPS-based systems that are placed on the last car of a train. The logistics in maintaining an end-of-train sensor on the last car are problematic. In particular, railways, particularly freight railways, split and join trains during their routine operations. This requires end-of-train devices to be manually transferred from one car to another as the trains reconfigure. Furthermore, this method requires that power is available throughout the train to power the device, or that the battery status of the end-of-train devices is monitored and controlled to assure proper operation. Also, while monitoring brake line pressure is an approved method for detecting train pull-apart, that procedure alone does not meet the standard for a safety-critical determination.

In view of the foregoing, the art would benefit from an improved system and approach to train detection and determining train integrity.

### SUMMARY OF THE INVENTION

The present invention provides a system and method for train detection/integrity determination that is handled exclusively via onboard systems. That is, the detection and integrity determination functions are performed without trackside equipment, thus providing the potential for significant cost savings. By supplementing the train detection/integrity functionality with information on system latencies, guard zones, processing delays and a determination of safe braking distance, the method and system can provide safety-critical onboard positive train separation information. This information, when transmitted to a control center, provides the data necessary to maintain safe separation distances between trains.

In accordance with the illustrative embodiment of the present invention, train detection is segregated into:

a safety-critical head-of-train determination;

a safety-critical end-of-train (or length-of-train) determination; and

a safety-critical train integrity function.

The safety-critical head-of-train determination is provided by an onboard safety-critical location determination system. The safety-critical end-of-train (or length-of-train) determination and the train integrity function are provided by onboard software running in a safety-critical processor. The input data to the software are provided by proven onboard systems (e.g., sensors, etc.), driver input, a track database, block-occupancy information provided by the traffic control center and data supplied by the Management Information System (MIS) in the strategic control center upon train initialization. In some embodiments, end-of-train determination is supplemented by data supplied by an end-of-train system, to the extent available.

The safety-critical end-of-train determination is computed from the head-of-train information (from the location determination system) and from a determination of train length (via software). The train length is computed from information supplied by the operator and the Management Information System. The train length determination is verified and monitored during operation based on block occupancy data from the traffic control center, when available.

Train weight is determined on the basis of operator input, MIS and tag reader data if available. The train weight information is verified and monitored by during operational periods on the basis of locomotive tractive energy.

The safety-critical train-integrity functionality comprises train pull-apart detection and, to the extent available, end-of-train data. This function determines when train integrity is lost through a train break. This determination is made on the basis of onboard data including, for example, brake-pipe pressure, locomotive tractive force, train weight, track database information, and, if available, an end-of-train system.

Brake-pipe pressure is monitored to determine if a train break has occurred as indicated by a loss of brake line pressure. Tractive energy is monitored to determine if a train break has occurred by a change in tractive force in pulling a train of known length and weight through the geometry represented in the track database.

Safe braking distance is computed based on train speed from the location determination system, train weight, train length, train brake performance and status information, track grade and curvature information obtained from a track database and system latencies/guard zones and processing delays. The safe braking distance, train detection, and integrity determination are transmitted to the control center. This information is used by the control center to determine safe separation distances between trains.

The method and system described herein adds a robustness that satisfies a higher safety classification (i.e., safety critical) relative to the prior art for operation on passenger and freight lines. And the method and system described herein provides train detection and integrity without the need for (1) expensive and high maintenance trackside equipment, such as track circuits and axle counters, or (2) an onboard end-of-train system.

### BRIEF DESCRIPTION OF THE DRAWINGS

FIG. 1 depicts a train having all the functionality required for onboard determination of safety-critical positive train separation information in accordance with the illustrative embodiment of the present invention.

FIG. 2 depicts a flow diagram of a method for operating a railway network in accordance with the illustrative embodiment of the present invention.

FIG. 3 depicts further detail of the method shown in FIG. 2.

FIG. 4 depicts a block diagram of the functional elements of onboard train detection, as used in conjunction with the method shown in FIG. 2.

FIG. 5 depicts a block diagram of end-of-train detection, as used in accordance with the present teachings for onboard train detection, as per FIG. 4.

FIG. 6 depicts a block diagram of train-integrity detection, as used in accordance with the present teachings for onboard train detection, as per FIG. 4.

FIG. 7 depicts a diagram that summarizes some of the more significant “functions” performed by software running in an onboard computer for the purpose of developing the positive train separation data, as well as the sources of input for these functions.

### DETAILED DESCRIPTION

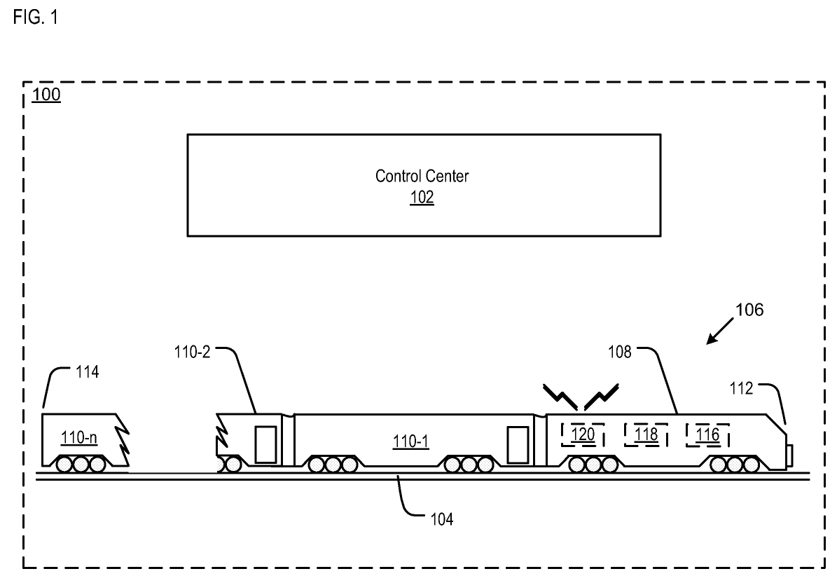

FIG. 1 depicts a portion of railway network 100. The portion of the network depicted in FIG. 1 includes control center 102, rail track 104, and train 106.

Control center 102 coordinates and manages train movements, monitors the operation of signaling and control systems, and receives (from trains, etc.) and develops information and reports regarding train performance, composition, and scheduling. In railway network 100, control center 102 is one of a plurality of distributed network control centers. In some other embodiments, a single control center is used to control the entire railway network.

Rail track 104 typically consists of two parallel steel rails, which are laid upon sleepers or cross ties that are embedded in ballast. The rail is fastened to the ties with rail spikes, lag screws or clips.

Train 106 comprises a plurality of connected rail vehicles that move along rail track 104 to transport freight or passengers from one place to another. In the illustrative embodiment, train 106 includes locomotive 108, which provides power, and a plurality of attached railcars 110-i, where i=1, n. The term “consist” is used to describe the group of rail vehicles that make up a train.

Train 106 is characterized by head (or “head-of-train”) 112, which is located at the forward end of the first rail vehicle in the consist (i.e., locomotive 108) and end (or “end-of-train”) 114, which is located at the rearward end of the last rail car (i.e., railcar 110-n). The length of train 106 is the distance between head 112 and end 114 measured along the track.

Train 106 includes equipment for performing train detection/integrity functions. In accordance with the illustrative embodiment of the invention, train detection and integrity is determined exclusively using onboard systems. That is, the determination does not rely on track circuits, axle counters, or even end-of-train devices.

More particularly, these functions are performed using a location determining system 116 and computer 118. Train 106 also includes communications equipment 120 for communicating with control center 102 or other trains (not depicted) operating on railway network 100.

Location determining system 116 autonomously determines the location of train 106 without requiring any trackside components. In most embodiments, the location determining system is not physically located at the head of train (as depicted in FIG. 1), but, rather, is located there virtually by offsets in the software running in its computer.

In some embodiments, location determining system 116 comprises a global positioning system (GPS), or a differential global positioning system (DGPS), as well one or more inertial devices, such as gyroscopes, accelerometers, and the like. These sensors can be used in conjunction with a data base of track geometry and location to enhance location determination accuracy. The reason for the inertial devices is that system 116 must be able to determine which track a train occupies with much higher confidence than is possible with GPS (or DGPS) alone when there are closely-spaced parallel tracks. Also, system 116 must be capable of dead reckoning in areas in which there is no GPS coverage (tunnels, steep valleys, areas with substantial electromagnetic interference (EMI) and radio frequency interference (RFI)). Thus, output from one or more inertial sensors are blended with available GPS or DGPS and compared against an onboard track database to determine safety-critical train location. Those skilled in the art will know how to use GPS or DGPS in conjunction with inertial sensors to determine the location of a train on a railway. (It might be possible to derive safety-critical train determination without inertial components when next-generation improvements in local and/or space-based GPS augmentation systems are available.)

Although GPS relies, of course, on satellites, it is considered for the purposes of this disclosure and the appended claims to be a system that is a component of onboard resources exclusively. This type of system is to be distinguished from a system that uses trackside transponders, etc., which communicate with receivers on board a train. The distinction being made is that a system that uses “onboard resources exclusively” will not require any trackside equipment nor, more generally, will it require that the operator, etc., of the railway network provide any additional off-board infrastructure for the train detection or integrity determination functions.

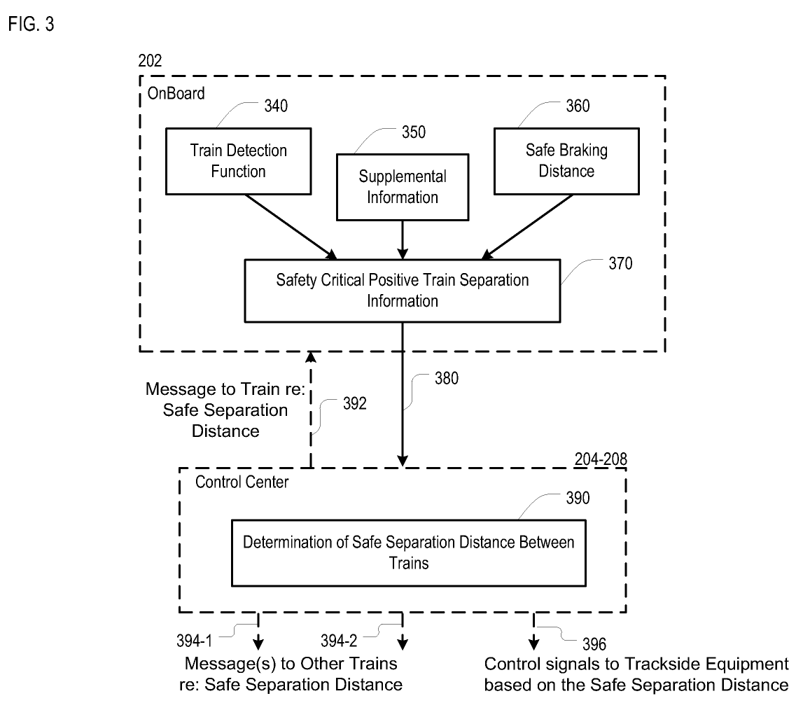

Computer 118 has a processor and is configured to operate software capable of performing tasks that are depicted in FIGS. 3 through 7 and described further below. The computer has appropriate input (e.g., keyboard, wired data, input, network connectivity, etc.) and output (e.g., display screen, etc.) capabilities as well access to one or more types of memory (e.g., for storing computed quantities, retrieving data, storing software, etc.).

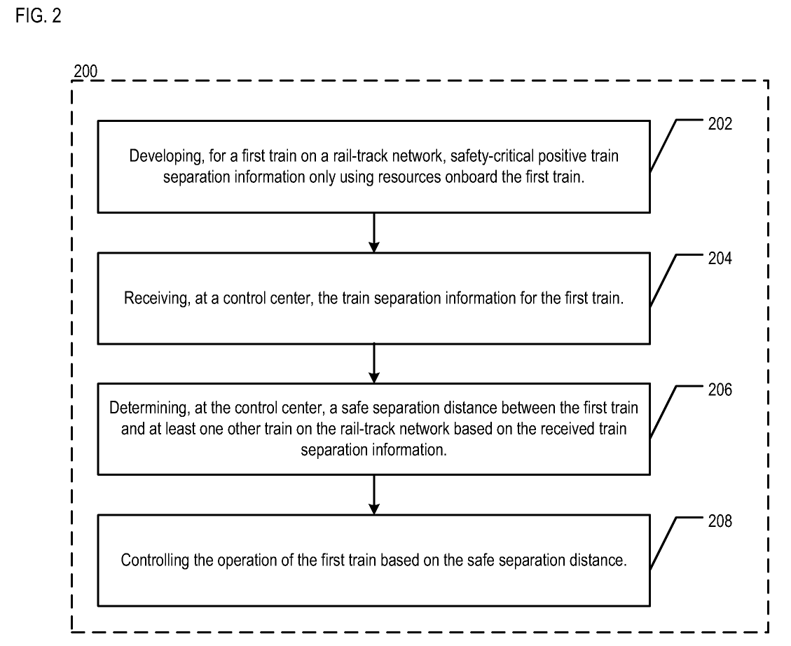

FIG. 2 depicts a flow diagram of method 200 for operating a railway network in accordance with the illustrative embodiment of the present invention. It is to be understood that the tasks recited in method 200 are being performed for a plurality of trains operating on the railway network.

Task 202 of method 200 recites developing, for a first train on a rail track network, safety-critical positive train separation information using onboard resources exclusively. This task is described in more detail with respect to FIGS. 3-7.

Task 204 of method 200 recites receiving, at the control center, the train separation information that is developed by the first train as per task 202. The information is transmitted to the control center, such as control center 102, via communications equipment 120 (see, e.g., FIG. 1).

Task 206 of method 200 recites determining, at the control center, a safe separation distance between the first train and at least one other train on the rail track network (i.e., the nearest train on the same track) based on the train separation information transmitted by the first train. In the illustrative embodiment, this determination is performed via software operating on a processor at the control center. In some alternative embodiments, this determination can be performed via software operating on computer 118 onboard the first train (assuming information about neighboring trains is available).

Task 208 of method 200 recites controlling the operation of the first train based on the safe separation distance that was calculated at the control center. This task involves transmitting a message to the first train as to the required separation distance and enforcing it. In some embodiments, this task also involves controlling various trackside equipment (e.g., signals, etc.) to enforce the safe separation distance.

FIG. 3 depicts a further illustration of method 200 and identifies some of the functionality required for accomplishing task 202 of method 200. In particular, developing safety-critical positive train separation information 370 involves a train detection function 340, a determination of safe braking distance 360, and certain supplemental information 350. The supplemental information includes, without limitation, information pertaining to system latencies, guard zones and processing delays. This information is sourced from the computer that is operating onboard the train.

The safety-critical positive train separation information 370 is transmitted by the first train, via communications channel 380, to the control center. In the illustrative embodiment, software running on a computer at the control center determines the safe separation distance for the first train from positive train separation information 370.

Message 392 pertaining to the safe separation distance is transmitted from the control center to the first train. Messages 394-1, 394-2 pertaining to the safe separation distance are transmitted from the control center to other trains near to and on the same track as the first train.

Control signal(s) 396 are transmitted from the control center to trackside equipment (e.g., signaling equipment, etc.) to enforce the safe braking distance.

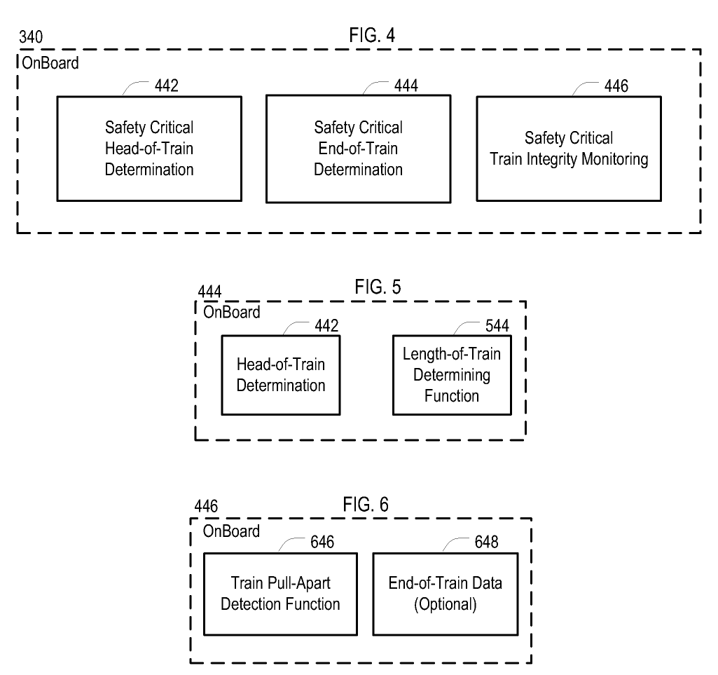

FIG. 4 depicts a block diagram of the functional elements of onboard train detection, as used in conjunction with method 200. In accordance with the illustrative embodiment, train detection 340 is accomplished via three safety-critical processes: head-of-train determination, end-of-train (or train length) determination, and train integrity. These three safety-critical processes are performed exclusively via onboard resources.

In particular, head-of-train determination 442 is performed via onboard location determining system 116 (see FIG. 1 and the accompanying disclosure). The onboard location determining system is a combination of GPS or DGPS and inertial measurements possibly in conjunction with a track data base, as previously described.

As depicted in FIG. 5, end-of-train determination 444 is based on head of train determination 442 (from the location determination system) and train length, as determined via software. The train length is computed from information supplied by the operator and the Management Information System. Input data includes, without limitation, consist data, train weight, locomotives characteristics, locomotive tractive energy, locomotive dynamic braking energy, number of loaded cars, number of unloaded cars, lading speed restrictions, equipment speed restrictions, brake pipe pressure, number of inoperative brakes and the network grade and curvature data available in the track database.

Train integrity function 446 determines when train integrity is lost through a train break. As per FIG. 6, train integrity 446 is based on train pull-apart detection 646 and, optionally, end-of-train data 648 to the extent it's available. Pull-apart detection 646 is made on the basis of onboard data including, for example, brake-pipe pressure, locomotive tractive force, train dynamic braking energy, train weight, train length, end-of-train data, and track database information.

Brake-pipe pressure is monitored to determine if a train break has occurred as indicated by a loss of brake line pressure. Tractive energy is monitored to determine if a train break has occurred by a change in tractive force in pulling the train weight through the geometry represented in the track database. Dynamic braking energy can be monitored to aid in train weight determination.

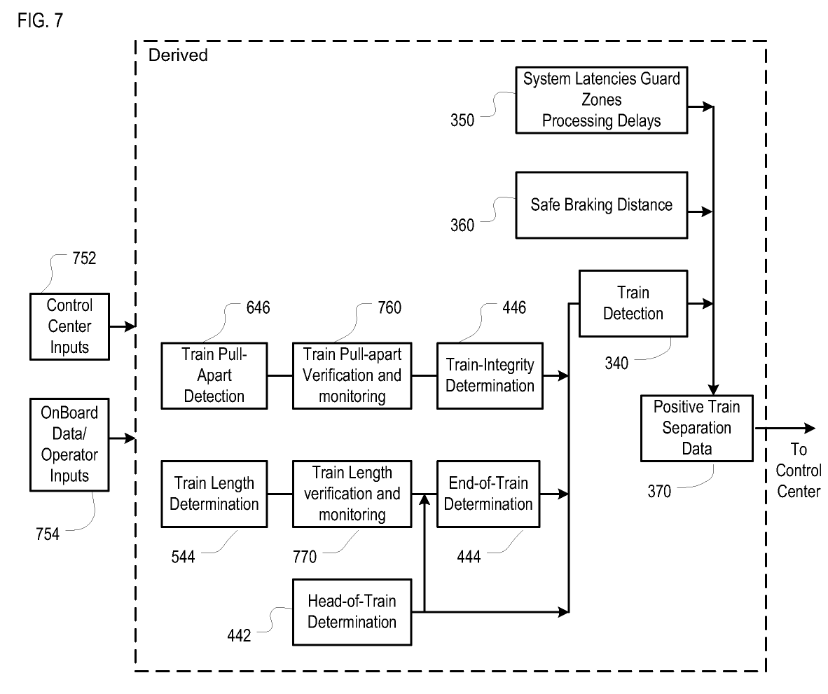

FIG. 7 provides a diagram that summarizes some of the more significant “functions” performed by software running in an onboard computer for the purpose of developing the positive train separation data, as well as the sources of input for these functions.

Inputs include control center inputs 752 and onboard data/operator inputs 754. Control center inputs 752 include, without limitation, block occupancy information (from the traffic control center), tag reader data, and data supplied by the Management Information System (MIS) (in the strategic control center) upon train initialization. Data supplied by the MIS includes, without limitation, the number of loaded cars, the number of unloaded cars, lading speed restrictions, and equipment speed restrictions.

Onboard data/operator inputs 754, which include information from onboard sensors as well as other sources, include, without limitation, the track database, train length, train weight, visual inspection data, brake line pressure, location determining system data. The track database contains information that associates track features with geo-locations. If an end-of-train system is present, information from this system can be used as well.

As previously discussed, head-of-train determination 442 is performed via location determining system 116. The head-of-train determination is used in conjunction with train length determination 544 that is performed in the software to determine end-of-train 444. Train length is computed from onboard data/operator inputs 754 (e.g., length of train, train weight, visual inspection) as well as data from the MIS (e.g., consist information, RFI tag data). The train length determination is verified and monitored during operation by train length verification and monitoring function 770. This is performed based on block occupancy data from the control center.

Train-integrity determination 446 is performed via software based on train pull-apart detection 646, as previously discussed. The pull-apart determination is verified and monitored during operation via train pull-apart verification and monitoring function 760. In some embodiments, this is performed based on block occupancy data from the control center and train weight, among other parameters.

Train weight, as is used in some embodiments in conjunction with train-integrity determination 446 and for other purposes, is determined on the basis of operator input, MIS and tag reader data, to the extent available. In operation, train weight is verified and monitored on the basis of measured tractive energy. Train dynamic braking energy may be used to aid train weight determination.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A method for operating a railway network, comprising:
developing, for a first train on the railway network, safety-critical positive train separation information using onboard resources exclusively;
receiving, at a control center, the train separation information for the first train;
determining, at the control center, a safe separation distance between the first train and at least one other train on the railway network based on the train separation information; and
controlling the operation of the first train based on the determined safe separation distance.

2. The method of claim 1 wherein the operation of controlling the operation of the first train further comprises sending a message to the first train, wherein the message contains information pertaining to the safe separation distance.

3. The method of claim 1 further comprising the operation of verifying all data that is used to develop the safety-critical positive train separation information.

4. The method of claim 1 wherein the operation of developing safety-critical positive train separation information further comprises determining safe braking distance.

5. The method of claim 4 wherein safe braking distance is determined as a function of one or more parameters selected from the group consisting of train speed, train weight, train length, train brake performance and status information, track grade, track curvature, system latencies, and processing delays.

6. The method of claim 1 wherein the operation of developing safety-critical positive train separation information further comprises:
determining head-of-train via a first onboard resource;
determining end-of-train via a second onboard resource; and
determining train integrity from via a third onboard resource.

7. The method of claim 6 wherein the operation of determining head-of-train further comprises using an on-board location determining system.

8. The method of claim 6 wherein the operation of determining train integrity further comprises using onboard data, wherein the data comprises one or more parameters selected from the group consisting of brake-pipe pressure, locomotive tractive force, train dynamic braking energy, train weight, train length, track database information, and end-of-train data.

9. The method of claim 6 wherein the operation of determining end-of-train further comprises uses head-of-train and train length information, as obtained from onboard resources.

10. The method of claim 9 wherein the train length is determined from one or more parameters selected from the group consisting of consist data, train weight, locomotive characteristics, locomotive tractive energy, locomotive dynamic braking energy, number of loaded cars, number of unloaded cars, lading speed restrictions, equipment speed restrictions, and number of inoperative brakes.

11. The method of claim 10 wherein train weight is determined based one or more parameters selected from the group consisting of operator input, management information system data, and tag reader data.

12. A method for operating a railway network, comprising:
developing, for a first train on the railway network:
(a) a safety-critical head-of-train determination using onboard resources exclusively;
(b) a safety-critical end-of-train or length-of-train determination using onboard resources exclusively; and
(c) a safety-critical determination of train integrity using onboard resources exclusively;
determining, for the first train, safe braking distance;
transmitting the head-of-train, end-of-train or length-of-train, train integrity, and safe braking distance to a control center;
determining, at the control center, a safe separation distance between the first train and at least one other train; and
transmitting the safe separation distance to the first train and the at least one other train and requiring them to operate so as to maintain, as a minimum, the safe separation distance.

13. A method for operating a railway network, comprising:
performing, for a first train on the railway network, safety-critical determinations including:
(a) a safety-critical head-of-train determination using an onboard location system exclusively, wherein the onboard location system comprises a Global Positioning Receiver and at least one inertial measurement device;
(b) a safety-critical end-of-train or length-of-train determination using onboard resources exclusively, wherein the onboard resources comprise a safety critical processor running suitable software; and
(c) a safety-critical determination of train integrity using onboard resources exclusively, wherein the onboard resources comprise a safety critical processor running suitable software;
transmitting the safety-critical determinations to a control center;
determining, at the control center or in some embodiments onboard the train, a safe separation distance between the first train and at least one other train, or neighboring trains based on the safety-critical determinations; and
determining and providing the safe separation distance to the first train and at least one other train and requiring them to operate so as to maintain, as a minimum, the safe separation distance.
